(19) United States
(12) Patent Application Publication
(10) Pub. No.: US 2009/0039132 A1
(43) Pub. Date: Feb. 12, 2009

(54) Driving tool

(76) Inventor: Kouji Kubo, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/920,751

(22) PCT Filed: May 22, 2006
(86) PCT No.: PCT/JP2006/310159

§ 371 Date: Nov. 20, 2007

(30) Foreign Application Priority Data
May 25, 2005 (JP) 2005-152034

(51) Int. Cl. B25C 7/00; B25C 1/00

(52) U.S. Cl. 227/8

(57) ABSTRACT

A driving tool is provided with a contact arm 11 which can be moved in a vertical direction along an eject path 6 of a nose part 4 disposed in a lower portion of a tool body 2. When driving a nail, the contact arm 11 is moved upward with respect to the nose part 4 to thereby activate an operation of a trigger 10 which is used to operate a starting trigger valve 12. The contact arm 11 is held between two upper and lower springs 20 and 21 which are respectively disposed in a vicinity of the nose part 4. The contact arm 11 is urged by the upper spring 23 so that a lower end of the contact arm projects downwardly beyond a lower end of the nose part 4.

### TECHNICAL FIELD

The present invention relates to a contact mechanism in a driving tool such as a nail driving tool and a screw driving tool for safety.

### BACKGROUND ART

Generally, a driving tool is used to drive a fastener such as a nail or a screw into wood or concrete. Normally, the driving tool includes a contact mechanism which is used to secure the safety of the driving tool. Specifically, the contact mechanism is used to make effective or activate a start operation of a trigger valve for starting the driving tool only when a contact member, which can be relatively moved along a nose part including a fastener eject path, is pressed to a member to be fastener-driven. The contact member is normally urged by a spring in such a manner that it projects in a fastener driving direction beyond the leading end of the nose part; and, in a fastener driving operation, when the leading end of the contact member is pressed to the member to be fastener-driven until a leading end of the nose part is butted to the driving portion of the member to be fastener-driven, the contact member is relatively moved in an opposite direction to a pressing direction, and the relative movement of the contact member shows the detection that the leading end of the nose part has been butted to the member to be fastener-driven, thereby being able to activate the operation of a trigger.

As described above, since the contact member is spring urged such that it projects in the fastener driving direction beyond the leading end of the nose part, when the contact member is pressed to the member to be fastener-driven, it is strongly pressed with a force equal to or greater than the load of the spring. Therefore, when a fastener is driven into a facing material, for example, when a pin nail is driven into a groove formed in a skirting board, because the leading end of the nose part is formed fine so as to be engageable with the groove, there is a fear that, owing to an impact generated when the fine leading end is pressed to the member to be fastener-driven, a flaw such as an impression can be produced on the surface of the member to be fastener-driven. When the surface of the member to be fastener-driven is finished poor, in some cases, the fastener driving operation must be started again. In view of this, as a safety operation to be executed before the driving operation, the contact member must be pressed to the member to be fastener-driven with a force slightly greater than the spring force and thus an operator is required to pay very fine attention to an adjustment of the pressing force, which results in the troublesome operation.

In JP-A-2002-283253, there is disclosed a mechanism in which a contact member is normally held on the top dead center side thereof, that is, the leading end of the contact member and the leading end of the nose part are held at the same position and, simultaneously when a trigger is pulled, the contact member is projected downward; and, in this case, when the contact member is contacted with the member to be fastener-driven and is thereby unable to project, the operation of the trigger is activated, whereas, when the contact member is projected without being contacted with anything, the operation of the trigger is deactivated. According to this mechanism, the leading end of the nose part may only be pressed against the member to be fastener-driven and there is not required a safety operation separately from the operation of the trigger, which makes it possible to carry out the driving operation quickly.

However, in the structure in which the contact member is urged by the spring to the top dead center, when the leading end of the contact member is pressed to the member to be fastener-driven for the first time, there is provided no cushioning property by the spring at all. Therefore, when a fastener is driven into a soft member to be fastener-driven, for example, a facing material such as the above-mentioned skirting board, it is inevitable that the a flaw or a dent can be produced on the surface of such member.

### DISCLOSURE OF THE INVENTION

One or more embodiments of the invention provide a contact mechanism for use in a driving tool which can prevent a member to be fastener-driven from an impression such as a flaw or an impression such as a dent and also can be operated easily.

According to one or more embodiments of the invention, a driving tool is provided with a contact member which can be moved in a vertical direction along an eject path formed in a nose part disposed in a lower portion of a tool body for driving a fastener. A lower end of the contact member is projected beyond a leading end of the nose part. In a fastener driving operation, by moving the contact member upward with respect to the nose part, an operation of a trigger for operating a starting trigger valve is activated. The contact member is held between two springs which are respectively disposed in upper and lower portions of a neighboring portion of the nose part. The lower end of the contact member is urged by an upper spring in such a manner that it is projected beyond the lower end of the nose part.

According to one or more embodiments of the invention, when the trigger is pulled, the contact member may also be moved downward against an urging force of the lower spring in linking with a valve stem of the trigger valve.

According to one or more embodiments of the invention, since the contact member is held between the upper and lower springs, the contact member has a cushioning property; and, since a stroke of the contact member, when a fastener is driven actually, may be short, it is easy to control a force necessary to press the contact member. Also, since the contact member is structured so as to extend along the eject path of the nose part and hardly meshes with other composing members or a fastener when it moves in the vertical direction, the contact member can be moved smoothly and the weight of the contact member can also be reduced, resulting in the small spring load of the upper spring. Therefore, since the contact member can be pressed against the member to be fastener-driven with a small force in a short stroke, even when a fastener is driven into a member to be fastener-driven made of soft material, not only the surface of the member to be fastener-driven is difficult to produce a flaw or a dent but also the contact member is easy to operate.

Also, in the pulling operation of the trigger, when the contact member is further moved downward against the urging force of the lower spring by the valve stem of the trigger valve, the driving tool is prevented from starting its operation even if the trigger is pulled. This can secure the safety of the driving tool.

Other aspects and advantages of the invention will be apparent from the following description and the appended claims.

### BRIEF DESCRIPTION OF THE DRAWINGS

FIG. 1 is a perspective view of an example of a nail driving tool according to an exemplary embodiment of the invention.

FIG. 2 is a side view of the nail driving tool, showing the structure of the trigger valve peripheral portion thereof.

FIG. 3 is a partially sectional view of the nail driving tool, when a safety device is viewed from the opposite side lateral surface thereof.

FIG. 4 is a section view of the shaft member portion of the nail driving tool.

FIG. 5 is an enlarged view of the lower arm portion of the nail driving tool.

FIG. 6 is a transverse section view of the leading end portion of a nose part of the nail driving tool.

FIG. 7 is an explanatory view of the state of engagement between an upper arm and first and second contact levers.

FIG. 8 is an explanatory view of a state in which a trigger is operated or pulled without pressing a lower arm against a member to be nail-driven.

FIG. 9 is an explanatory view of a state in which a trigger is operated or pulled correctly.

### DESCRIPTION OF REFERENCE NUMERALS

1: Nail driving tool
4: Nose part
12: Trigger valve
10: Valve stem
11: Contact arm
20: Upper spring
21: Lower spring

### BEST MODE FOR CARRYING OUT THE INVENTION

Now, description will be given below of an exemplary embodiment of the invention with reference to the accompanying drawings.

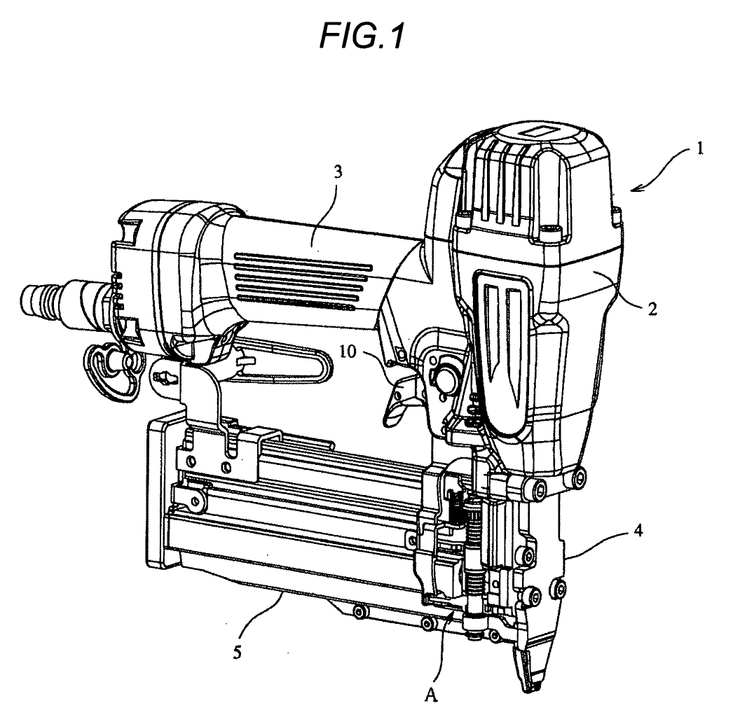

In FIGS. 1 to 3, reference numeral 1 designates a nail driving tool (driving tool). This nail driving tool 1 includes a tool body 2 having a striking mechanism, a grip 3 disposed backwardly of the tool body 2, a nose part 4 disposed in the lower end portion of the tool body 2, and a rectangular-shaped magazine 5 for supplying connected nails (pin nails) to the nose part 4, in which the leading one of the connected nails supplied from the magazine 5 to an eject path 6 formed in the nose part 4 is driven by a driver 7 integrally connected to a striking piston constituting the striking mechanism. The eject path 6 is formed between a driver guide 8 constituting the front wall of the nose part 4 and a wear plate 9 constituting the front wall of the nose part 4.

To drive out a nail, by pulling a trigger 10 to actuate a starting trigger valve 12, compressed air supplied from an air compressor is fed to the striking mechanism and the above-mentioned leading nail is driven out by the pressure of the compressed air. Referring more specifically to the pulling operation of the trigger 10, when a contact arm 11 functioning as a contact member is actually pressed against a member to be nail-driven by a contact arm mechanism A functioning as a contact mechanism (which will be shown below), the trigger valve 12 can be operated effectively.

By the way, the trigger valve 12 is the same as a conventionally known trigger valve in which, when the compressed air is supplied from the air compressor, a valve stem 13 is pushed downward out of the trigger valve 12 and this valve stem 13 is then pushed upward into the trigger valve 12 by the trigger 10, whereby the trigger valve 12 is operated so as to start the nail driving operation of the nail driving tool.

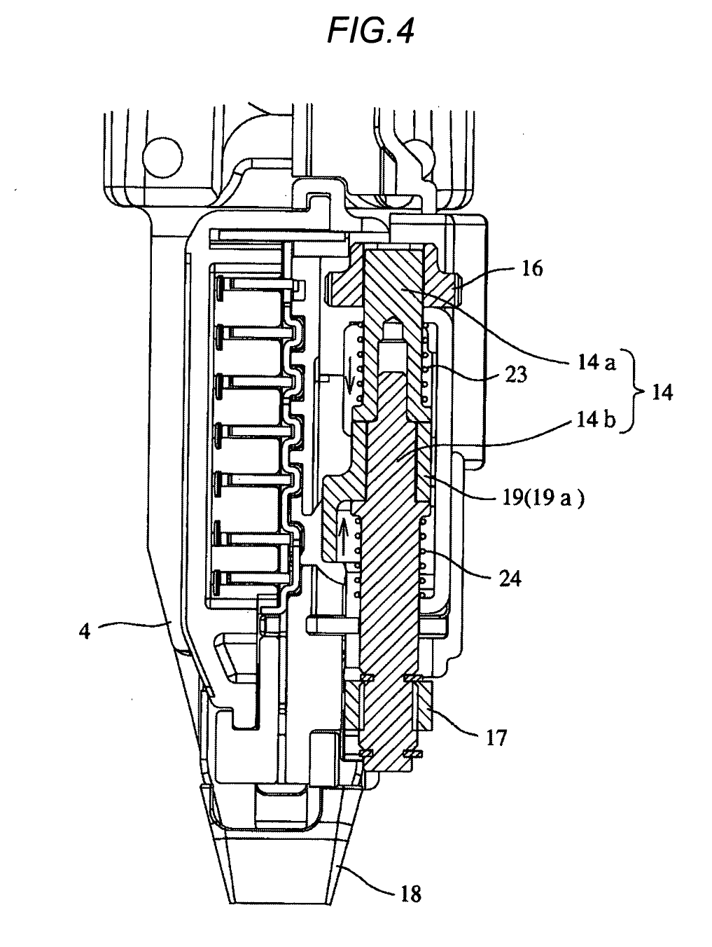

The contact arm mechanism A includes a contact arm 11 provided integrally with a shaft member 14 movable parallel to the axis of the nose part 4, and an upper arm 15 disposed upwardly of the contact arm 11. As shown in FIG. 4, the shaft member 14 is a unified body of an upper shaft member 14a and a lower shaft member 14b, while the lower shaft member 14b is formed such that it is prevented from rotating with respect to the upper shaft member 14a. Also, with the upper portion of the upper shaft member 14a, there is threadedly engaged an adjust dial 16 and, by turning the adjust dial 16, the vertical position of a connecting arm 17 can be adjusted.

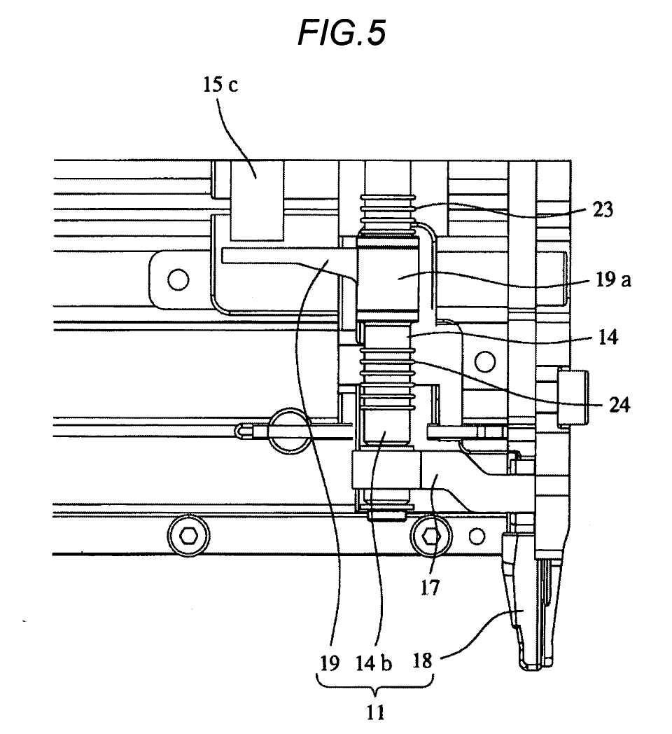

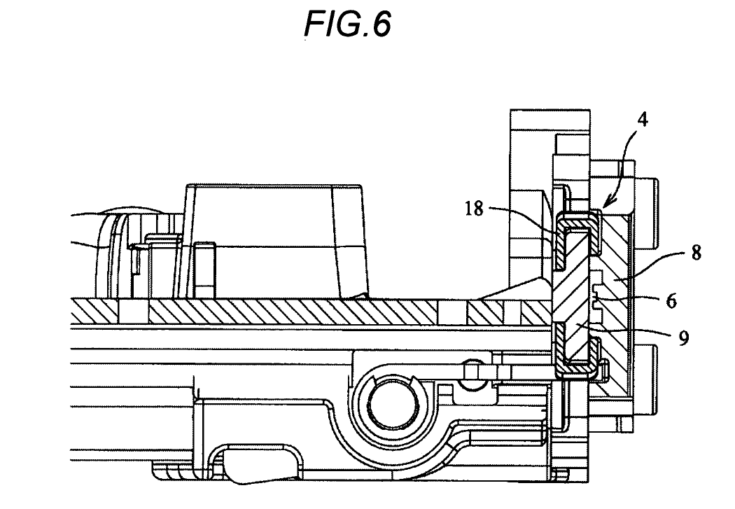

The contact arm 11, as shown in FIG. 5, includes the above-mentioned lower shaft member 14b, a contact portion 18 disposed to face downward and connected to the lower shaft member 14b through the connecting arm 17 bent at right angles from the lower portion of the lower shaft member 14b, and an operation arm 19 bent at right angles from the middle portion of the lower shaft member 14b. By the way, the contact portion 18, as shown in FIG. 6, is formed separately from the wear plate 9 and is disposed in such a manner that it can be moved in the vertical direction along the rear surface of the wear plate 9.

As shown in FIG. 4, the base portion 19a of the operation arm 19 is formed in a cylindrical shape, while the cylindrical-shaped base portion 19a is fixed to the upper end of the lower shaft member 14b. And, in the magazine 5, there are formed two spring receive portions 21 and 22 at the positions thereof that respectively correspond to the upper and lower portions of the shaft member 14; and, between the upper and lower spring receive portions 21, 22 and the above-mentioned operation arm 19, there are interposed upper and lower springs 23 and 24. Owing to this structure, the contact arm 11 can be held between the upper and lower springs 23 and 24; and, the contact arm 11 can be moved upward against the urging force of the upper spring 23, while it can be moved downward against the urging force of the lower spring 24. The stroke of the contact arm 11 from the above-mentioned stop position to the lower moving end thereof is set about half the stroke of a conventional one.

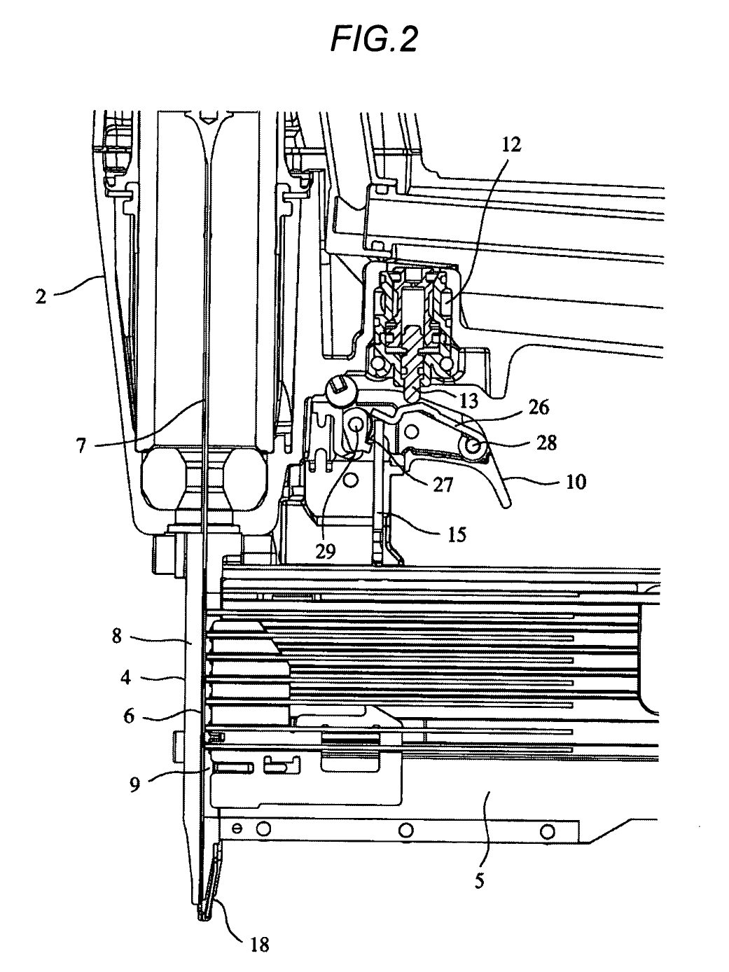

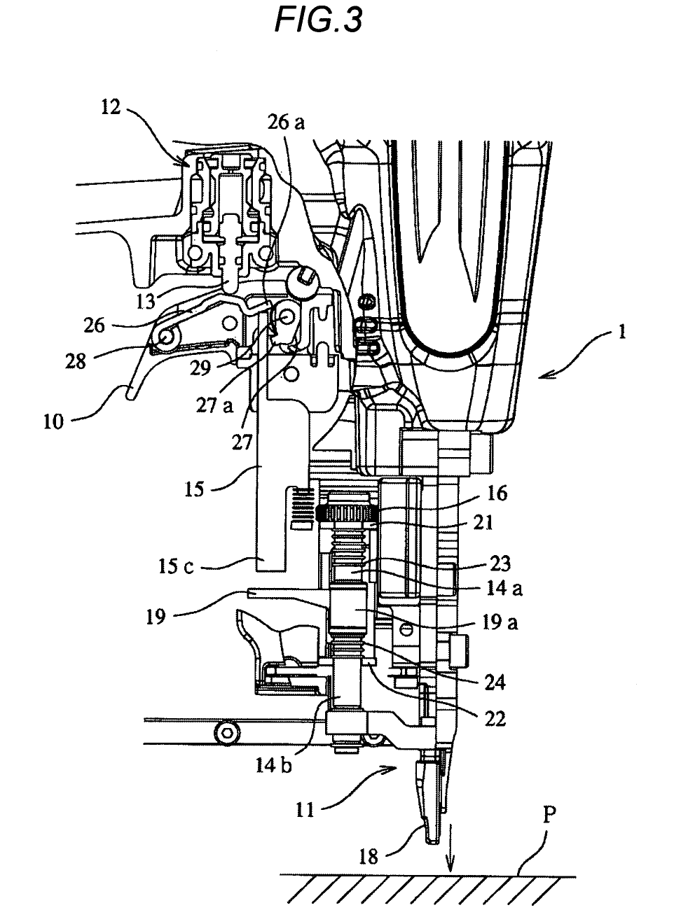

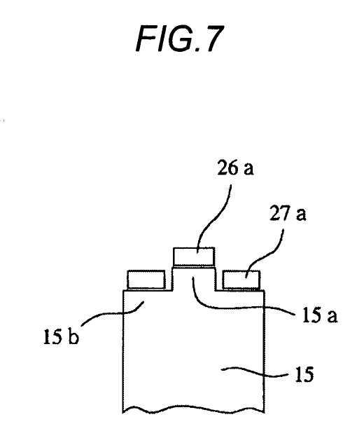

As shown in FIGS. 2 and 3, the upper arm 15 is disposed on the upper portion of the operation arm 19 in such a manner that it can be moved in the vertical direction, while the upper arm 15 is urged by a spring 25 in such a manner that it is situated at its upper position. Also, as shown in FIG. 7, the upper end portion of the upper arm 15 is formed such that the central portion 15a thereof is higher than the two shoulder portions 15b thereof.

On the upper portion of the upper arm 15, there is disposed the trigger 10. As shown in FIGS. 2 and 3, within the trigger 10, there are disposed first and second contact levers 26 and 27 in such a manner that they can be rotated about their respective support shafts 28 and 29 respectively. The upper arm 15 is interposed between the first and second contact levers 26 and 27. The leading end 26a of the first contact lever 26 is formed such that it can be engaged with the central portion 15a of the upper end of the upper arm 15, whereas the leading end 27a of the second contact arm 27 is formed to be engageable with the two shoulder portions 15b.

The middle portion of the first contact lever 26 is situated downwardly of the valve stem 13 of the starting trigger valve 12, while the leading end thereof, as described above, is situated upwardly of the upper arm 15. And, in a state where the upper arm 15 has moved upward, when the trigger 10 is pulled up by pushing up the leading end side of the first contact lever 26, the contact arm 11 pushes the valve stem 13 into the trigger valve 12 to thereby operate the trigger valve 12.

Also, the second contact lever 27 is urged by a spring in such a manner that, when the trigger 10 is pulled, it can be projected upwardly of the upper arm 15 in linking with the pulling operation of the trigger 10.

In the above-mentioned structure, normally, the contact arm 11 is situated at the lower position thereof by the upper spring 23, while the contact portion 18 of the leading end of the contact arm 11 is projected downwardly of the nose part 4.

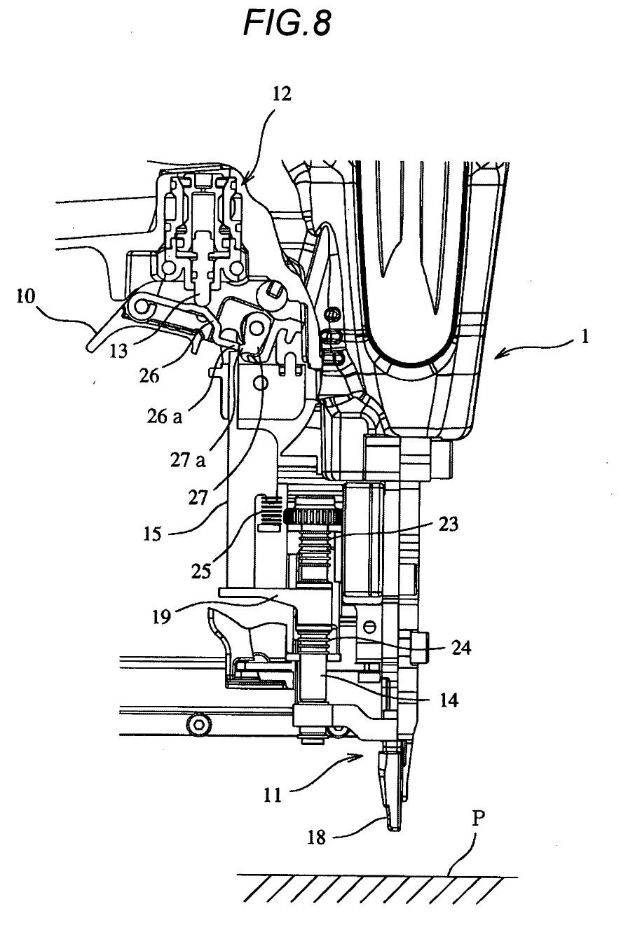

When the trigger 10 is pulled up in this state, as shown in FIG. 8, since the valve stem 13 of the trigger valve 12 is pushed downward out of the trigger valve 12 by the compressed air, the first contact lever 26 is swung with its engaged portion with the valve stem 13 as a fulcrum thereof, while the leading end 26a thereof pushes down the upper arm 15 against the urging force of the spring 25. Because the lower end of the upper arm 15 is engaged with the operation arm 19, the shaft member 14 and contact portion 18 together with the operation arm 19 are also projected further downward against the urging force of the lower spring 24. Therefore, at the then time, the nail driving tool does not start its driving operation.

Also, when the trigger 10 is pulled in this manner, as described above, the upper arm 15 is projected downward; and, therefore, simultaneously with the downward projecting movement of the upper arm 15, the second contact lever 27 is rotated and its leading end 27a projects upwardly of the upper arm 15. After then, even when the contact portion 18 of the contact arm 11 is pressed against the member to be nail-driven P, as shown in FIG. 7, since the leading end 27a of the second contact lever 27 is engaged with the shoulder portions 15b of the upper end of the upper arm 15, the upper arm 15 is prevented from moving upward and thus the first contact lever 26 is unable to push up the valve stem 13, thereby deactivating the above-mentioned operation of the trigger 10. That is, when the contact portion 18 is pressed against the member to be nail-driven P, the contact arm 11 is moved upward against the urging force of the upper spring 23 and is simultaneously going to move the upper arm 15 upward; however, the shoulder portions 15b of the upper end of the upper arm 15 are engaged with the leading end 27a of the second contact lever 27, which prevents the upper arm 15 against its upward movement. For this reason, even when the trigger 10 is pulled, the first contact lever 26 is prevented against upward movement and thus the valve stem 13 of the trigger valve 12 cannot be pushed into the trigger valve 12, so that the nail driving tool 1 is prevented from starting its operation. Therefore, it is impossible to carry out a so called contact driving operation in which, in a state where the trigger 10 is pulled, the leading end of the contact arm 11 is pressed against the member to be nail-driven to thereby drive a nail into the member to be nail-driven.

By the way, without the second contact lever 27, the contact driving operation is possible.

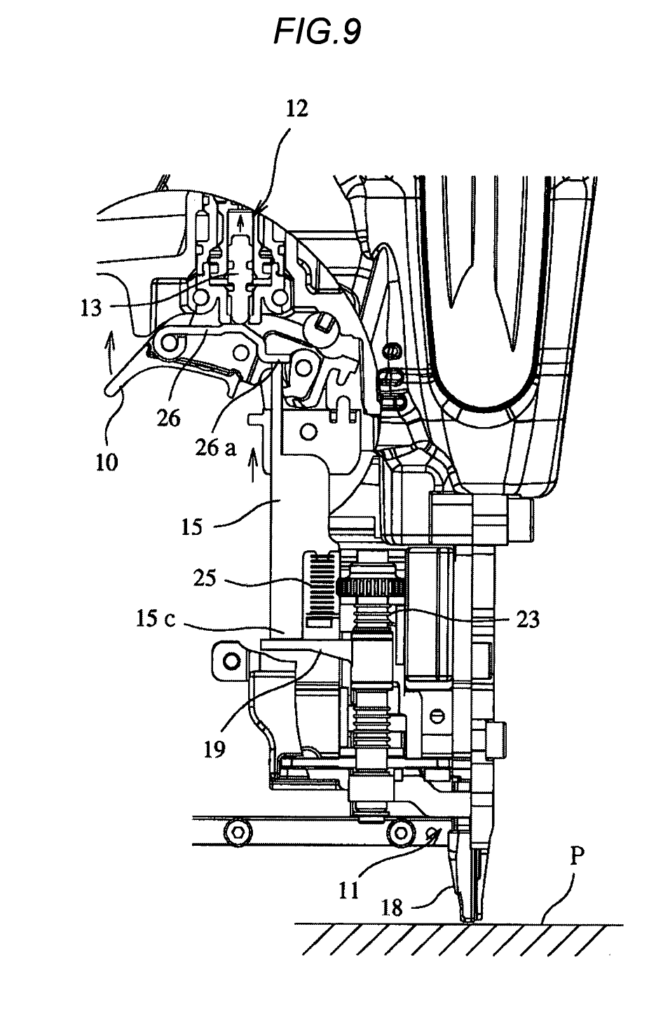

To drive a nail into the member to be nail-driven correctly, as shown in FIG. 9, firstly, the contact portion 18 of the contact arm 11 is pressed against the member to be nail-driven. In response to this, the contact arm 11 is relatively moved upward against the urging force of the upper spring 23, so that the operation arm 1.9 is moved just below the lower end 15c of the upper arm 15 existing upwardly of the operation arm 19. When the trigger 10 is pulled in this state, the first contact lever 26 is swung with its engaged portion with the valve stem 13 of the trigger valve 12 as a fulcrum thereof, while the leading end 26 thereof is going to push down the upper arm 15 against the urging force of the spring 25. However, the lower end 15c of the upper arm 15 is engaged with the operation arm 19, which prevents the upper arm 15 from lowering down any further. Therefore, since the first contact lever 26 is rotated with its engaged portion with the upper end of the upper arm 15 as a fulcrum thereof, the middle portion of the first contact lever 26 pushes up the valve stem 13 into the trigger valve 12 to thereby operate the trigger valve 12, which makes it possible to start the nail driving operation of the nail driving tool 1.

By the way, when, after the upper arm 15 has moved upward, the trigger 10 is pulled up, the second contact lever 27 is unable to project upwardly of the upper arm 15 because the upper arm 15 is in the way of the second contact lever 27.

As described above, since the contact arm 11 is held between the two upper and lower springs 23 and 24, the contact arm 11 itself has a cushioning property and the stroke of the contact arm 11 in the actual nail driving operation may be short, which makes it easy to control a force necessary to press the contact arm 11 against the member to be nail-driven. And, because the stroke of the contact arm 11 is small and also the contact arm 11 is provided independently of the eject path 6 of the nose part 4, when the contact arm 11 moves up and down, it hardly meshes with other members or the nail, so that it is allowed to move smoothly. Also, since the contact arm 11 is simple in structure and light in weight, the spring load of the upper spring 23 may be set small. Therefore, even when driving a fastener into a member to be fastener-driven which is made of soft material, the contact arm 11 can be pressed against the member to be fastener-driven with a small force, which makes it difficult to generate a flaw or a dent on the surface of the member to be fastener-driven.

By the way, when the stroke of the contact arm 11 is long, the spring load is large and the pressing force is strong. Therefore, when the leading end of the nose part 4 is butted against the surface of the member to be fastener-driven, the impact is strong. In order to avoid such strong impact, attention must be paid to the pressing force, which results in the troublesome operation of the driving tool. On the other hand, according to the present embodiment, since the stroke of the contact arm 11 is short and the spring load of the upper spring 23 is small, the operation efficiency of the driving tool can be enhanced.

Here, the contact arm 11 may be structured such that it can move parallel to the axis of the nose part 4, that is, it can move along the eject path 6. Therefore, the lower shaft member 14b, connecting arm 17 and operation arm 19 may be structured such that they can move in linking with each other in the vertical direction; and, therefore, they are not limited to their shapes and connecting modes. The upper arm 15 and operation arm 19 may also be formed separately from each other. Or, there may also be employed a structure in which the upper arm 15 and operation arm 19 are formed as an integral body, while the operation arm 19 is bent and extended upwardly of the upper arm 15. In this structure, provision of the spring 25 is not necessary.

Further, the stroke of the contact arm 11 is not always limited to half the stroke of the conventional contact arm. That is, it may be longer or shorter than half the stroke of the conventional arm.

By the way, in the above-mentioned embodiment, description has been given of an example of the contact mechanism in which there is used the contact arm formed separately from the nose part. However, there may also be used a contact nose in which the leading end of the nose part plays the role of a contact.

Also, the invention is not limited to a nail driving tool. The invention can also be applied not only to a screw driving tool or a pneumatic tool but also to a driving tool which is driven by electric power.

Although the invention has been described heretofore in detail with reference to its specific embodiment, it is obvious to a person skilled in the art that other various changes and modifications are also possible without departing from the spirit and scope of the invention.

The present application is based on the Japanese Patent Publication (Patent Application 2005-152034) filed on May 25, 2005 and thus the contents thereof are incorporated herein.

### INDUSTRIAL APPLICABILITY

The invention can be applied to a contact mechanism employed in a driving tool such as a nail driving tool or a screw driving tool for safety.

1. A driving tool comprising:
a nose part disposed in a lower portion of a tool body for driving a fastener;
a contact member disposed to be movable in a vertical direction along an eject path of the nose part;
an upper spring; and
a lower spring,
wherein the contact member is held between the upper spring and the lower spring, and
the contact member is urged by the upper spring so that a lower end of the contact member projects downwardly beyond a lower end of the nose part.

2. The driving tool according to claim 1, wherein an operation of a trigger for operating a starting trigger valve is activated by moving the contact member upward with respect to the nose part, in driving the fastener.

3. The driving tool according to claim 1, wherein the contact member is moved downward against an urging force of the lower spring in linking with a valve stem of a trigger valve when the trigger is pulled.
